(19) United States
(12) Patent Application Publication
(10) Pub. No.: US 2014/0082269 A1
(43) Pub. Date: Mar. 20, 2014

(54) EMBEDDED MULTIMEDIA CARD (eMMC), HOST CONTROLLING SAME, AND METHOD OF OPERATING eMMC SYSTEM

(71) Applicant: SAMSUNG ELECTRONICS CO., LTD., Suwon-si (KR)

(72) Inventors: YOUNG GYU KANG, YONGIN-SI (KR); KWAN HO KIM, SUWON-SI (KR)

(73) Assignee: SAMSUNG ELECTRONICS CO., LTD., Suwon-si (KR)

(21) Appl. No.: 14/026,046

(22) Filed: Sep. 13, 2013

(30) Foreign Application Priority Data
Sep. 14, 2012 (KR) 10-2012-0102476

(51) Int. Cl. G06F 12/02

(52) U.S. Cl. CPC G06F 12/0246
USPC 711/103

(57) ABSTRACT

A method of operating an eMMC system includes a host sending SEND_EXT_CSD command to obtain busy control clock information from an eMMC. The busy control clock information is then used to control provision of a host-provided clock to the eMMC while the eMMC is in a busy state.

### CROSS-REFERENCE TO RELATED APPLICATIONS

This application claims priority under 35 U.S.C. §119(a) from Korean Patent Application No. 10-2012-0102476 filed Sep. 14, 2012, the subject matter of which is hereby incorporated by reference.

### BACKGROUND

Embodiments of the inventive concept relate generally to embedded multimedia cards (eMMC) and eMMC systems including a host and an eMMC. More particularly, certain embodiments of the inventive concept relate to eMMC having reduced power consumption while outputting a busy signal to a host. Other embodiments of the inventive concept relate to hosts controlling the operation of this type of eMMC, as well as methods of operating eMMC systems.

The so-called multimedia card (MMC) is a flash memory card standard. The eMMC is an embedded MMC standard defined by the Joint Electron Devices Engineering Council (JEDEC). In general configuration and application eMMCs are designed to be inserted (or “embedded”) in conjunction with a host within mobile communication devices such as smart phones. Conventionally, the eMMC communicates data signals, control signals, commands, clock(s) and/or power signals with the connected host in accordance with a standardize ten (10) signal line bus.

Those skilled in the art will understand that various JEDEC standards are available that characterize and/or define the structure, constitution and/or operating parameters of certain eMMCs. These standards may be readily obtained and consulted by recourse to http://www.jedec.org. For example, the embedded multimedia card (eMMC) electrical standard, version 4.51 published June 2012 (i.e., JESD84-B451) contains many terms and technical definitions that are useful to an understanding of the inventive concept described hereafter.

For example, accompanying FIG. 9 is a timing diagram illustrating a so-called “R1b response” by an eMMC that operated according to JESD84-B451. As shown in FIG. 9, the eMMC receives a clock signal via a clock signal line, a sequence of commands via a command signal line, and a multiplicity of data signals via a data bus including eight (8) data signal lines (i.e., DAT[7:0]). When the eMMC receives an R1b type command from the host, the eMMC conventionally return a “busy signal” to the host via one of the data signal lines (i.e., DAT0), together with an R1 response that is communicated via the command signal line. The busy signal essentially indicates a “busy state” for the eMMC to the host.

While the eMMC is in the busy state, the host will continuously communicate the clock signal to the eMMC via the clock signal line. The duration of any particular busy state period will vary between several microseconds (μs) to several milliseconds (ms) depending on the type of command communicated by the host and/or the computational capabilities of the eMMC. Using this approach, the host is able to determine when the eMMC is released from the busy state. However, this approach also causes the host to consume a considerable amount of power as it continuously provides the clock signal to the eMMC during busy states of extensive duration.

### SUMMARY

According to certain embodiments of the inventive concept, there is provided a method of operating an embedded multimedia card (eMMC) system including an eMMC having an extended card specific device (EXT_CSD) register and a host connected to the eMMC via a clock line, a command/response line and a data bus. The method comprises; communicating a SEND_EXT_CSD command from the host to the eMMC via the command/response line, and in response to the SEND_EXT_CSD command, communicating eMMC information stored in the EXT_CSD register including busy control clock information to the host via the data bus, wherein the busy control clock information controls provision by the host of a clock to the clock line during a busy state for the eMMC.

According to certain embodiments of the inventive concept, there is provided an eMMC system, comprising; an embedded multimedia card (eMMC) and a host connected via a command/response channel, a clock channel, and a data channel, wherein the eMMC includes an extended card specific device (EXT_CSD) register that stores eMMC information including busy control clock information, and the host is configured to determine whether or not to provide a clock to the clock channel while the eMMC is in a busy state in response to the busy control clock information.

According to certain embodiments of the inventive concept, there is provided a method of operating an eMMC system, the eMMC system including an embedded multimedia card (eMMC) and a host connected via a command/response channel, a clock channel, and a data channel. The method comprises; operating the eMMC in response to a clock received from the host via the clock channel while the eMMC is in a busy state during a first eMMC operating mode, and operating the eMMC in response to an internal clock generated within the eMMC while the eMMC is in the busy state during a second eMMC operating mode, wherein the first and second eMMC operating modes are defined by eMMC information stored in an extended card specific device (EXT_CSD) register.

### BRIEF DESCRIPTION OF THE DRAWINGS

FIG. 1 is a block diagram of an eMMC system including an embedded multimedia card (eMMC) and a host according to embodiments of the inventive concept;

FIG. 2 is a table listing commands that may be provided from the host to the eMMC in the eMMC system of FIG. 1;

FIG. 3 is a diagram illustrating a busy clock control field that may be used in certain embodiments of the inventive concept;

FIG. 4 is an operating diagram illustrating eMMC/host state relationships during operation of the eMMC system of FIG. 1;

FIG. 5 is a timing diagram illustrating signal relationships corresponding to the eMMC system operation of FIG. 4;

FIG. 6 is a block diagram further illustrating in one example a host/eMMC interface relationship that may be present in certain embodiments of the inventive concept;

FIG. 7 is a block diagram further illustrating in one example the busy signal detector of FIG. 6;

FIG. 8 is an operating diagram illustrating a method of operating an eMMC system according to embodiments of the inventive concept; and

FIG. 9 is a timing diagram illustrating signal timing relationships for a R1b response in an eMMC system conventionally operated according to JESD84-B451.

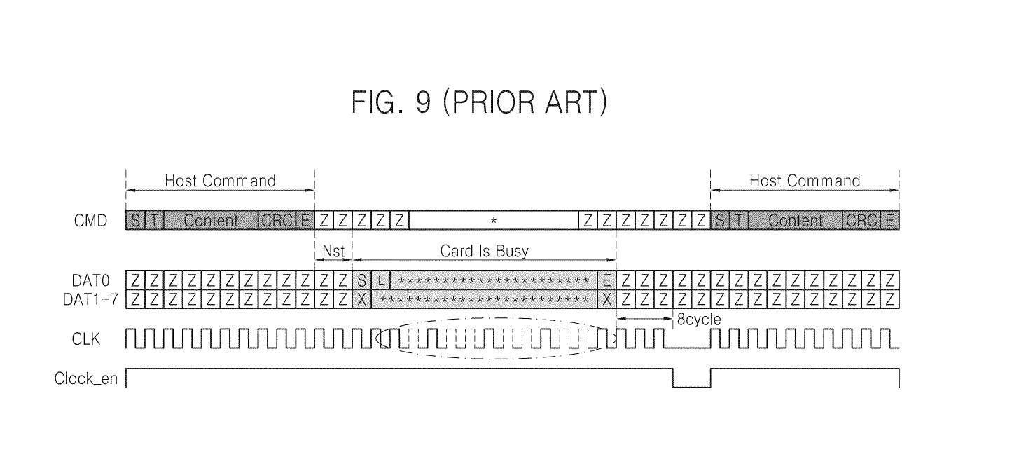

### DETAILED DESCRIPTION

Certain embodiments of the inventive concept now will be described in some additional detail with reference to the accompanying drawings. The inventive concept may, however, be embodied in many different forms and should not be construed as limited to only the illustrated embodiments. Rather, these embodiments are provided so that this disclosure will be thorough and complete, and will fully convey the scope of the invention to those skilled in the art. Throughout the drawings and written description, like reference numbers and labels are used to denote like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Within various embodiments of the inventive concept, the term “channel” is used to denote a signal path enabling the transmission of one or more electrical signal(s) (e.g., a voltage). As will be understood by those skilled in the art, a channel may include one or more of; circuits acting upon the one or more electrical signal(s), a host pad (and/or pin), an eMMC pad (and/or pin), a line (or collection of lines), a driver—specifically including but not limited to certain differential amplifiers, and a receiver—specifically including but not limited to certain differential amplifiers.

Various embodiments of the inventive concept may include at least one “additional” signal line or signal wire (hereafter, simply “line”) having a specific purpose. This additional line will be additive to the standard 10-wire configuration(s) specified by JEDEC standards. The provision of an additional line within certain embodiments of the inventive concept increases noise immunity and improves transmission speed for data communicated between a host and a device during a data read operation while operating in a dual data rate (DDR) mode. In this regard, pending U.S. patent application [U.S. Attorney Docket No. SEC.3341 claiming priority to Korean Patent Application No. 10-2012-0102467 filed on Sep. 14, 2012] is hereby incorporated by reference.

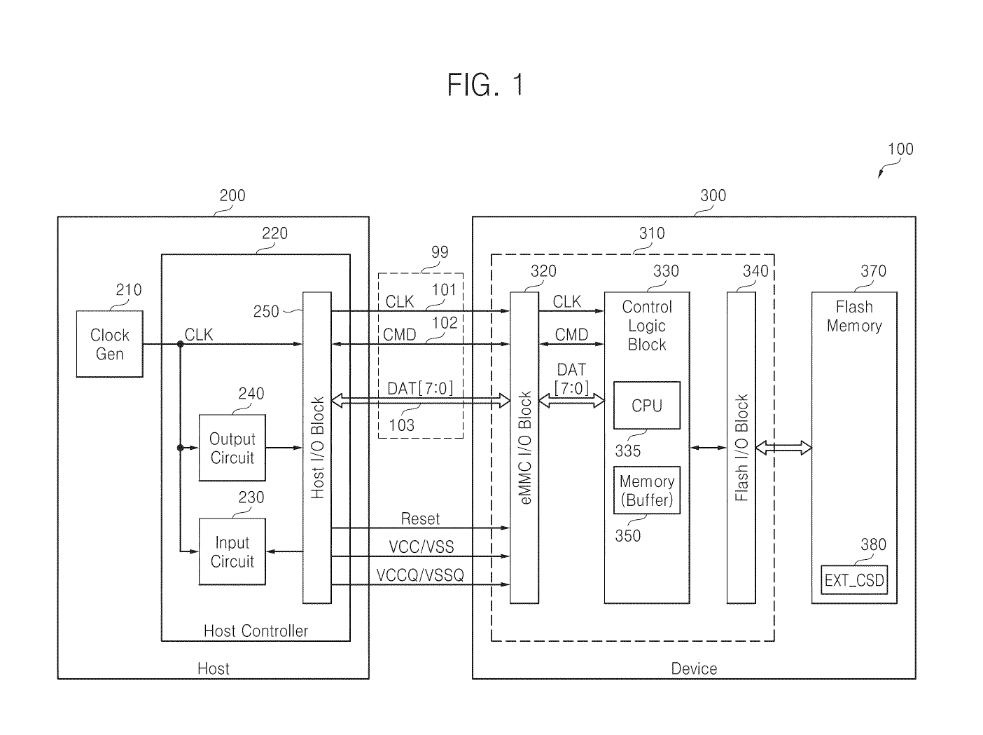

FIG. 1 is a block diagram of an eMMC system 100 according to embodiments of the inventive concept. The eMMC system 100 generally includes a host 200 and an eMMC 300.

The host 200 may be used to control the data processing operations (e.g., read/write operations) performed by the eMMC 300. Data processing operations may be performed using a single data rate (SDR) or a double data rate (DDR). Those skilled in the art will understand the general technical concepts and design options involved in providing a DDR mode of operation—specifically including so-called DDR 400. The host 200 may be a microprocessor or an application processor that is embedded or implemented in an electronic device. The electronic device may be (e.g.,) a personal computer (PC), a laptop computer, a mobile telephone, a smart phone, a tablet PC, a personal digital assistant (PDA), an enterprise digital assistant (EDA), a digital still camera, a portable multimedia player (PMP), a personal navigation device or portable navigation device (PND), an MP3 player, a handheld game console, or an e-book.

The host 200 includes a clock generator 210 and a host controller 220. The clock generator 210 may be used to generate a clock signal (CLK) (hereafter, “clock CLK”) that is used by the host 200 and/or the eMMC 300 as a reference signal. Thus, the eMMC 300 is routinely provided with the clock CLK by the host 200. The clock generator 210 may be conventionally implemented using a phase locked loop circuit or a delayed locked loop circuit. The host controller 220 of FIG. 1 includes an input circuit 230, an output circuit 240, and a host input/output (I/O) block 250.

During a read operation, the input circuit 230 receives “read data” via the host I/O block 250 that has been retrieved by the eMMC 300 from constituent flash memory 370, for example. In this regard, the input circuit 230 may initially receive start bit option information or valid window information that is stored in an extended card specific device (EX_CSD) register 380 of the eMMC 300 via the host I/O block 250. Using the output circuit 240 and host I/O block 250, the host 200 may communicate commands (CMD) in accordance with the start bit option information or the valid window information.

During a write operation and in response to the clock CLK, the output circuit 240 may be used to communicate “write data” to be written to the flash memory 370 in the eMMC 300 via the host I/O block 250.

In the eMMC system 100 of FIG. 1, it is assumed that an eMMC bus 99 includes the ten (10) lines indicated by corresponding JEDEC standards. These ten lines include a unidirectional clock line 101 used to communicate the clock CLK, a bidirectional command/response line 102 used to communicate commands from the host 200 to the eMMC 300 and to communicate responses from the eMMC 300 to the host 200, and a bidirectional data bus 103 including eight (8) data lines DAT[7:0] used to communicate data signals.

In addition, the host 200 is assumed to generate and communicate certain I/O operating voltages VCCQ and VSSQ used by the input circuit 230 and the output circuit 240, as well as the I/O operating voltages VCCQ and VSSQ to the eMMC 300. These power signals are communicated via separate power lines. For example, the host 200 may generates core operating voltages VCC and VSS used by the flash memory 370. In certain embodiments of the inventive concept, the voltages VSSQ and VSS may be ground voltages.

The eMMC 300 generally comprises an eMMC controller, 310 and flash memory 370. The eMMC controller 310 may be used to control the exchange of data between the host 200 and flash memory 370. In FIG. 1, the eMMC controller 310 includes eMMC I/O block 320, a control logic block 330, and a flash I/O block 340. When the flash memory 370 is implemented by NAND flash memory, the flash I/O block 340 may be implemented by a NAND flash I/O block.

During a write operation, write data received via the eMMC I/O block 320 may be temporarily stored in a buffer memory 350 under the control of a central processing unit (CPU) 335. Thereafter, the flash I/O block 340 may retrieve the write data from the buffer memory 350, and program the write data to the flash memory 370 under the control of the CPU 335.

During a read operation, the flash I/O block 340 may be used to move read data retrieved from the flash memory 370 in the buffer memory 350 under the control of the CPU 335. In one particular example, the flash I/O block 340 may be used to move the start bit option information or valid window information provided from the EXT_CSD register 380 to the buffer memory 350 under the control of the CPU 335.

Hence, the buffer memory 350 may be used to temporarily store read data and write data exchanged between the eMMC I/O block 320 and the flash I/O block 340. The memory 350 may be implemented as a volatile memory (e.g., DRAM or SRAM).

In the eMMC 300 of FIG. 1, the flash memory 370 includes the EXT_CSD register 380. The EXT_CSD register 380 may be sued to store “busy control information” characterizing the operation of the eMMC 300. For example, the busy control information may be stored in a “BUSY_W/O_CLOCK field” designated within the data stored by the EXT_CSD register 380.

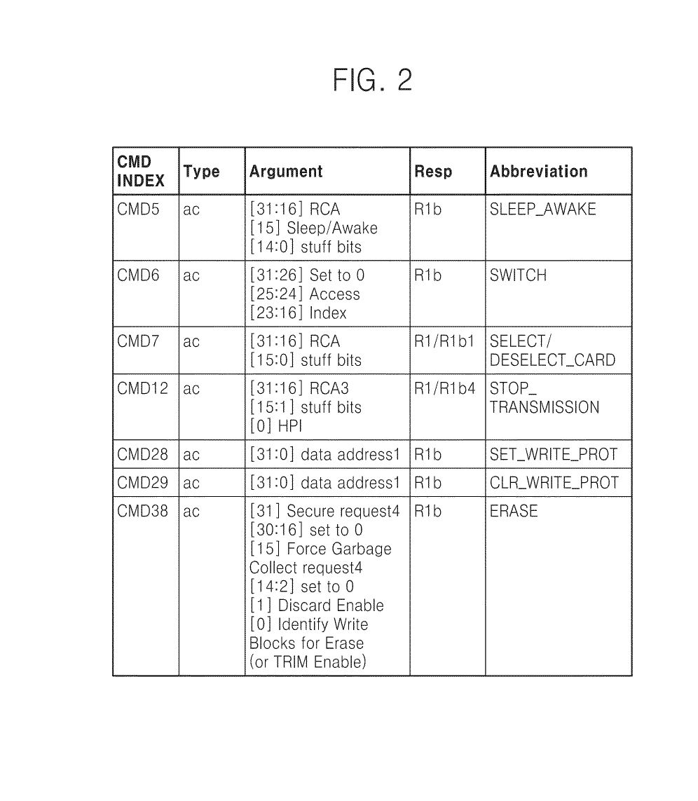

FIG. 2 is a table listing commands that may be provided by the host 200 to the eMMC 300 via the command/response line 102 within the eMMC system 100 of FIG. 1. It is assumed that each command CMD is 48 bits in length and has the format shown in Table 1.

TABLE 1

| | Bit Position | | | | | |
|---|---|---|---|---|---|---|
| | 47 | 46 | [45:40] | [39:8] | 7 | 0 |
| Width(bits) | 1 | 1 | 6 | 32 | x | 1 |
| Value | “0” | “0” | x | x | x | “1” |
| Description | Start | Trans- | Command | Argument | CRC7 | End bit |
| | bit | mission | Index | | | |
| | | bit | | | | |

Thus, each command includes a start bit indicating the start of the command, a transmission bit indicating the direction of transmission, a command index interpreted as a binary coded number, an argument coded in 32 bits, a cyclic redundancy code (CRC) preventing channel transmission errors, and an end bit indicating the termination of the command.

It is further assumed that for each command listed in FIG. 1 and communicated by the host 200 to the eMMC 300, a returned “R1b response” is required. Here, each R1b response may be communicated from the eMMC 300 to the host 200 via the command/response line. Each R1b response may be the same as an R1 response, and the format shown in Table 2 may be used to define each R1b response. In this regard, a busy signal may be selectively communicated together with the R1b response via (e.g.,) a first data channel (DAT0) associated with a first data line. It is further assumed that the eMMC 300 upon receiving a command will enter a busy state depending on the current (operative) state of the eMMC 300.

TABLE 2

| | Bit Position | | | | | |
|---|---|---|---|---|---|---|
| | 47 | 46 | [45:40] | [39:8] | 7 | 0 |
| Width(bits) | 1 | 1 | 6 | 32 | x | 1 |
| Value | “0” | “0” | x | x | CRC7 | “1” |
| Description | Start bit | Trans- | Command | Card | CRC7 | End bit |
| | | mission | Index | Status | | |
| | | bit | | | | |

Consistent with the foregoing it should be noted that the R1 response always begins with a start bit of “0”. A transmission bit indicating the direction of transmission follows the start bit. Then, 38 bits following the transmission bit include the content of the response, where 32 bits of these 38 bits may be used to indicate state information. In Table 2, the indication “x” is used to denote a variable dependent upon a command. The R1 response is protected by a CRC and is terminated with an end bit. In other words, as shown in Table 2, the format of the R1 response is similar to that of a command. However, the R1 response includes card status information instead of the argument.

As listed in FIG. 2, examples of commands for which the host 200 will receive an R1b response include: SLEEP_AWAKE (CMD5), SWITCH (CMD6), SELECT/DESELECT_CARD (CMD7), STOP_TRANSMISSION (CMD12), SET_WRITE_PROT (CMD28), CLR_WRITE_PROT (CMD 29), and ERASE (CMD38). Each of these commands is an address type command (ac). JESD84-B451 may be reference for a description of other commands.

Of particular note is the SWITCH (CMD6) that may be communicated from the host 200 to the eMMC 300 in order to (1) switch an operating mode of the eMMC 300, or (2) modify the data stored in the EXT_CSD register 380 of the eMMC 300. The data stored in the EXT_CSD register 380, amongst other possible functions, may be used to define “eMMC information”, where the eMMC information include various information characterizing the operative nature and capabilities of the eMMC 300. In the context of certain embodiments of the inventive concept, busy clock control information may be stored in the EXT_CSD register 380 as part of the eMMC information.

To obtain the eMMC information generally, or to obtain the busy clock control information specifically, the host 200 may send the SEND_EXT_CSD (CMD8) to the eMMC 300. The SEND_EXT_CSD (CMD8) is an address data transfer command. In the argument of SEND_EXT_CSD (CMD8), bits [31:0] are stuff bits, i.e., 0 bits. In response to SEND_EXT_CSD (CMD8), the eMMC 300 will return a R1 response and the busy clock control information stored in the EXT_CSD register 380 to the host 200. The busy clock control information may be used by the host 200 to control the provision of the clock CLK by the host 200 to the eMMC 300 while the eMMC 300 is in the busy state.

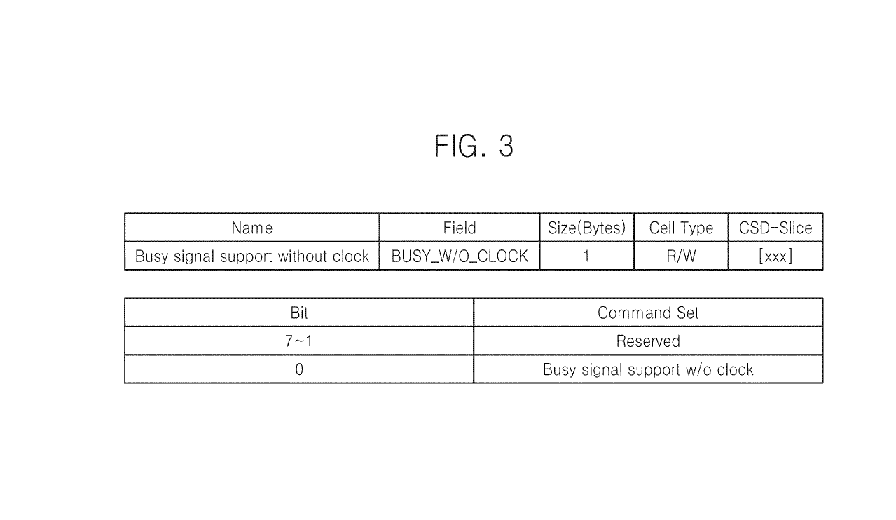

Thus, the EXT_CSD register 380 may be used to store data (e.g., 512 bytes) defining eMMC device properties and operating modes. In certain embodiments of the inventive concept, the busy clock control information may be stored in a single byte of the eMMC information data stored in the EXT_CSD register 380 using an appropriate format. However, one possible example approach to the definition of the busy control information will be described in some additional detail with reference to FIG. 3.

FIG. 3 is a diagram illustrating one example of a “busy clock control field” that may be included within eMMC information stored in the EXT_CSD register 380 according to embodiments of the inventive concept. Referring to FIG. 3, the BUSY_W/O_CLOCK field of the EXT_CSD register 380 defines a busy clock of the eMMC 300. An OUT_OF_INTERRUPT_TIME field and other fields are defined in JESD84-B451, but the BUSY_W/O_CLOCK field is added to the EXT_CSD register 380 by certain embodiments of the inventive concept in order to store information indicating how to gate (send/halt) the host-provided clock CLK depending on the busy state of the eMMC 300. For instance, the busy control information (i.e., busy signal support without (w/o) clock) may be stored in relation to a bit 0 for the data bus channel, while bits 1 through 7 [7:1] are reserved.

When the host 200 sends the SEND_EXT_CSD (CMD8) to the eMMC 300, the eMMC 300 will return a response (i.e., eMMC information dumped from the EXT_CSD register 380) including the BUSY_W/O_CLOCK field to the host 200. With the busy clock control information, the host 200 may determine whether the eMMC 300 supports a “busy clock control operation.”

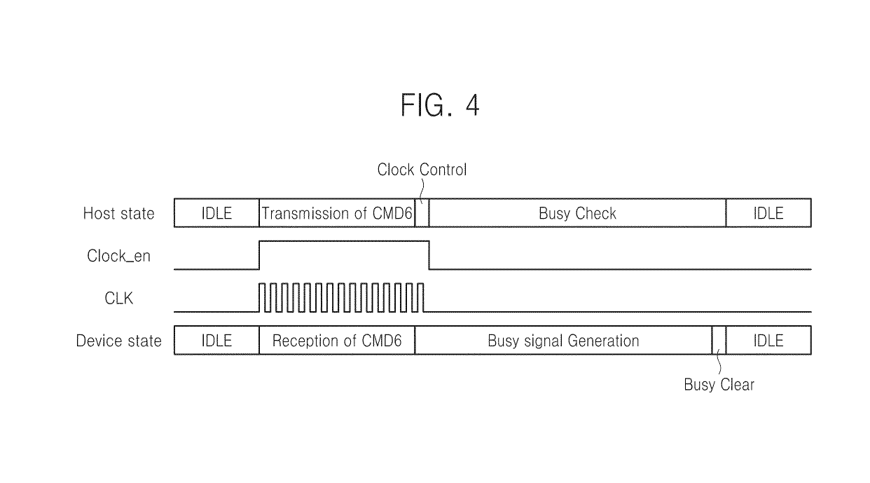

FIG. 4 is an operating diagram illustrating operation of the eMMC system 100 of FIG. 1. Referring to FIGS. 1 and 4, the host 200 is first assumed to be in an idle state, but then communicates an R1b type command (e.g., SWITCH (CMD6)) to the eMMC 300. The host 200 also communicates the clock CLK to the eMMC 300 in response to a clock enable signal (Clock_en).

Upon receiving the R1b type command from the host 200 while currently in the idle state, the eMMC 300 returns an R1b response to the host 200. The R1 response as shown in Table 2 and a busy signal sent as the R1b response correspond to busy signal generation period shown in FIG. 4.

Upon receiving the busy signal from the eMMC 300, the host 200 controls the communication of the clock CLK to the eMMC 300. In other words, the host 200 monitors the busy signal, and so long as the eMMC 300 remains in the busy state as indicated (e.g.,) by a “high” busy signal, the host 200 disables the clock enable signal, thereby halting provision of the clock CLK. After completing execution of whatever operation was indicated by the former command received from the host 200, the eMMC 300 clears the busy state and returns to the idle state. That is, once the eMMC 300 clears the busy state as indicated (e.g.,) by a “low” busy signal, the host 200 enters the idle state, or more particularly the host 200 will maintain the disabled clock enable signal until the eMMC 300 provides a new request to the host 200 or until the host 200 sends a new command to the eMMC 300. As a result, unless the host 200 must provide the clock CLK to the eMMC 300 as a requirement associated with an ongoing operation, the provision of the clock CLK will be halted so that power consumption in the idle state for the eMMC system may be reduced.

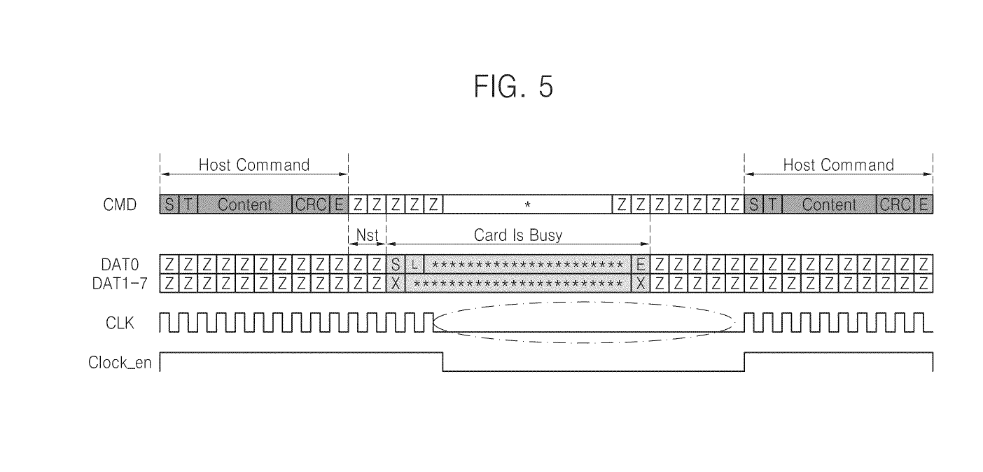

FIG. 5 is a more detailed timing diagram that further illustrates the interoperation of components (eMMC and host) in an eMMC system of FIGS. 1 and 4. Referring to FIGS. 1, 4 and 5, when the host 200 sends an R1b type command, and in response the eMMC 300 returns to the host 200 a busy signal together with an R1 response after a period “Nst” (i.e., two cycles) elapses since the reception of an end bit E of the host command.

The busy signal is then communicated via a data channel, i.e., DAT0. The busy signal is driven low to indicate a eMMC busy state period extending from a start bit S following the period Nst to an end bit E. Data channels DAT7 through DAT1 may be driven to “1” or “0” (or a don't care state “X”) during the busy state period.

The clock CLK is communicated via the clock line 101 while the command is being communicated via the command/response line 102 from the host 200 to the eMMC 300. Upon receiving the start bit S of the busy signal via the data channel DAT0 from the eMMC 300, the host 200 disables the clock enable signal (e.g., drives the clock enable signal low) in order to disable (off-gate) provision of the clock CLK. At this time, a predetermined latency may occur in controlling the host-provided clock CLK.

Upon receiving the end bit E of the busy signal, the host 200 need not immediately enable the clock enable signal, but may maintain the clock enable signal in its disabled state, pending some later event. For example, this later event may be the eMMC 300 communicating a next request to the host 200, or the host 200 communicating a next command to the eMMC 300. Whatever it nature the later event will cause the host 200 to change the clock enable signal from the disabled state to the enabled state to thereby cause provision of the clock CLK from the host 200 to the eMMC 300.

As a result, the host 200 need not drive the clock CLK onto the clock channel connecting the host 200 and eMMC 300 (and consume the power necessary to do so) until such time as it is actually needed (i.e., when the eMMC 300 requires it).

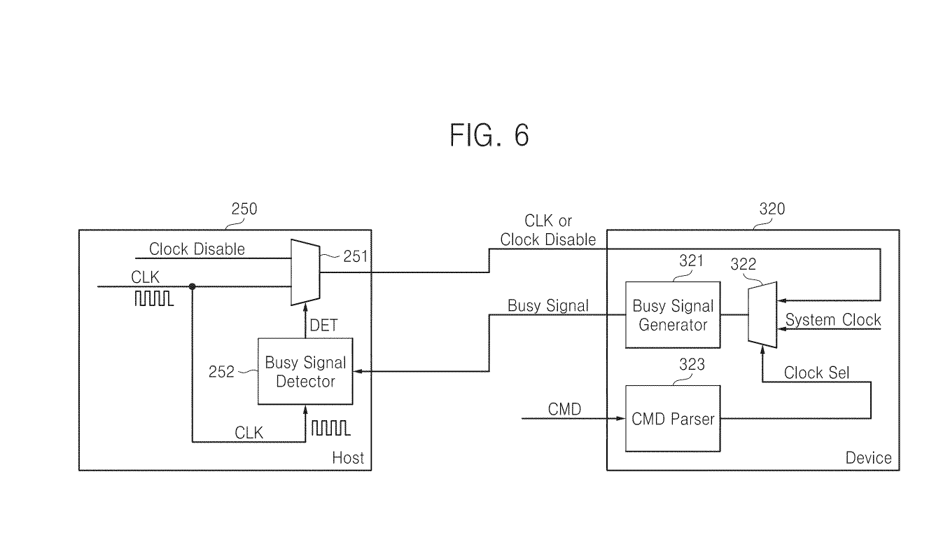

FIG. 6 is a somewhat more detailed block diagram illustrating the host BO block 250 and the eMMC I/O block 320 of FIG. 1 according to certain embodiments of the inventive concept. The host 200 receives a busy signal via the data channel DAT0 and the host I/O block 250 from the eMMC 300 and determines how (ON or OFF) to gate the clock CLK. In the specific embodiment of FIG. 6, the host I/O block 250 includes an output clock signal selector 251 and a busy signal detector 252.

The output clock signal selector 251 selects between the clock CLK and a clock disable signal in response to a detection signal (DET). For instance, when the eMMC 300 switches to the busy state (i.e., a state indicating that the “card-is-busy”), the output clock signal selector 251 may select the clock disable signal and halt provision of the clock CLK to the clock channel. Then, when the eMMC 300 clears the busy state, the output clock signal selector 251 may again select the clock CLK and enable provision of the clock CLK to the clock channel.

The busy signal detector 252 may be used to provide the detection signal (DET) when the eMMC 300 switches to the busy state in response to the clock CLK and the busy signal from the eMMC 300. In other words, when the start bit of the busy signal is detected on the data channel DAT0, the busy signal detector 252 outputs the detection signal DET such that the clock enable signal is disabled.

In the embodiment illustrated in FIG. 6, the eMMC 300 is able selects between the host-provided clock CLK or an internally generated system clock (or “internal clock”) according to a clock selection signal (Clock Sel). Thus, the eMMC 300 may operate in accordance with a selected one of two possible clock signals. The clock selection signal may be based on the command CMD received from the host 200, and the eMMC 300 may generate the busy signal as a function of the “selected clock”.

With reference to FIG. 6, the eMMC I/O block 320 includes a busy signal generator 321, an input clock signal selector 322, and a command parser 323. The busy signal generator 321 may be used to generate the busy signal according to the attribute of the selected clock provided by the input clock signal selector 322. The input clock signal selector 322 may be used to select between host-provided clock CLK or the internally generated system clock according to the type of the command CMD received from the host 200. In this regard, the command parser 323 may be used to parse the command CMD received from the host 200 and provide a resulting clock selection signal to the input clock signal selector 322.

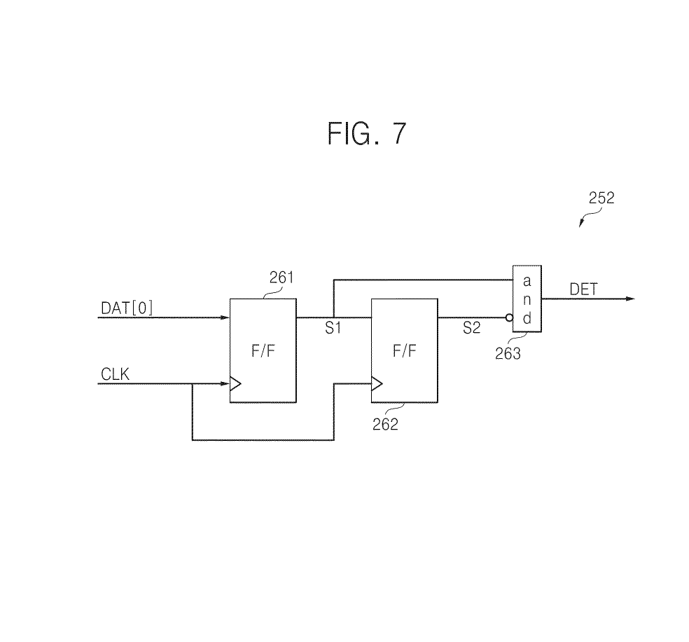

FIG. 7 is a somewhat more detailed block diagram of the busy signal detector 252 of FIG. 6. Referring to FIGS. 6 and 7, the busy signal detector 252 immediately outputs the detection signal DET when the eMMC 300 switches to the busy state based on the clock CLK and the busy signal. The busy signal detector 252 includes a first flip-flop (F/F) 261 that outputs a first signal 51 obtained by latching the busy signal received through the data channel DAT0 based on the clock CLK, a second F/F 262 that outputs a second signal S2 obtained by latching the first signal 51 based on the clock CLK, and a comparator 263 that compares an inverted version of the second signal S2 with the first signal 51 to generate the detection signal DET as a comparison result.

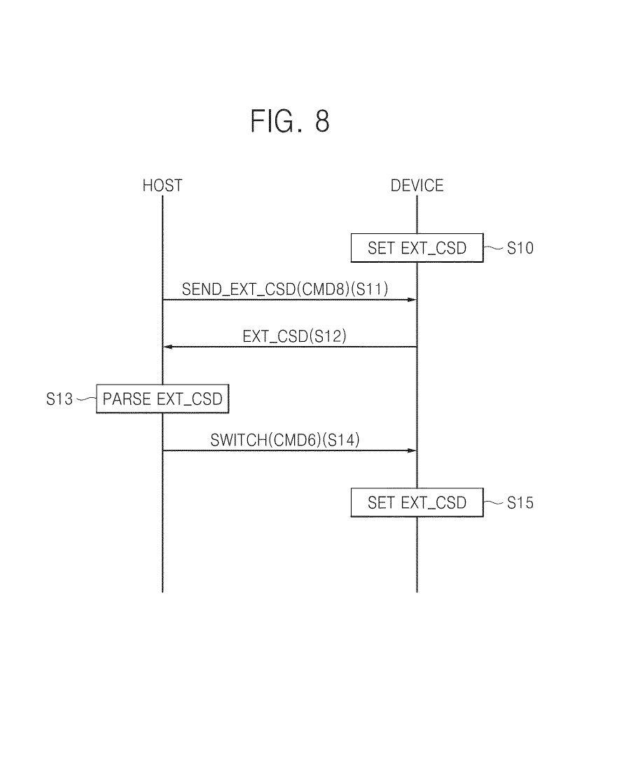

FIG. 8 is an operating diagram illustrating a method of operating the eMMC system 100 of FIG. 1 according to certain embodiments of the inventive concept. Busy control clock information is written to the EXT_CSD register 380 of the eMMC 300, possibly as part of a broader range of eMMC information (S10). In certain embodiments of the inventive concept, a particular data field within the data defining the eMMC information (e.g., the BUSY_W/O_CLOCK field of the EXT_CSD register 380) may be used to store the busy control clock information. At some point during operation of the eMMC system 100, possibly upon eMMC system initialization, the busy control clock information will be communicated to the host 200. As described above, the busy control clock information may be used by the host 200 to control provision of the clock CLK to eMMC 300.

The host 200 sends SEND_EXT_CSD (CMD8) to the eMMC 300 in order to obtain eMMC information including the busy control clock information (S11). In response, the eMMC 300 sends the data contents of the EXT_CSD register 380 including data related to the busy control clock information to the host 200 (S12).

The host 200 parses the busy control clock information from the BUSY_W/O_CLOCK field of the EXT_CSD (S13), for example, and then the host 200 may modify the contents of the EXT_CSD register 380 based on the busy control information, such that the eMMC 300 may operates without provision by the host 200 of the clock CLK. In other words, the host 200 may send a competent SWITCH (CMD6) to the eMMC 300 (S14) to alter the operating mode of the eMMC 300 in this regard.

Hence, the eMMC 300 will “set” the data stored in the EXT_CSD register 380 based on the SWITCH (CMD6) so that it operates without the host-provided clock CLK during a card-is-busy period (S15). As noted above in one particular embodiment, the card-is-busy period may be a period during which a busy signal and an R1 response are being transmitted from the eMMC 300 since the elapse of a predetermined time (Nst in FIG. 5) after an R1b type command is completely received from the host 200. During this time, the busy signal may low from a start bit to an end bit.

As described above, according to certain embodiments of the inventive concept, a host in an eMMC system may selectively provide a clock CLK to a clock channel when a corresponding eMMC is in a busy state to thereby reduce power consumption.

While the inventive concept has been particularly shown and described with reference to exemplary embodiments thereof, it will be understood by those of ordinary skill in the art that various changes in forms and details may be made therein without departing from the scope of the inventive concept as defined by the following claims.

What is claimed is:

1. A method of operating an embedded multimedia card (eMMC) system including an eMMC having an extended card specific device (EXT_CSD) register and a host connected to the eMMC via a clock line, a command/response line and a data bus, the method comprising:
communicating a SEND_EXT_CSD command from the host to the eMMC via the command/response line; and
in response to the SEND_EXT_CSD command, communicating eMMC information stored in the EXT_CSD register including busy control clock information to the host via the data bus,
wherein the busy control clock information controls provision of a clock by the host to the clock line during a busy state for the eMMC.

2. The method of claim 1, wherein the eMMC is selectively configurable to operate in response to the clock or an internal clock, and the method further comprises:
communicating a SWITCH command from the host to the eMMC in response to the busy control clock information, wherein the SWITCH command selects between a first eMMC operating mode responsive to the clock and a second eMMC operating mode responsive to the internal clock.

3. The method of claim 2, wherein the SWITCH command modifies the eMMC information stored in the EXT_CSD register.

4. The method of claim 1, wherein the busy control clock information is stored in a BUSY_W/O_CLOCK field of the EXT_CSD register.

5. The method of claim 1, wherein the eMMC enters the busy state only after a predetermined time period following receiving a R1b type command from the host.

6. The method of claim 2, further comprising:
generating and communicating a busy signal from the eMMC to the host via one data line of the data bus in response to the selection between the first and second eMMC operating modes.

7. The method of claim 6, further comprising:
generating a detection signal in the host in response to the busy signal and the clock; and
selecting between the clock and a clock disable signal to provide to the clock channel in response to the detection signal.

8. An eMMC system, comprising:
an embedded multimedia card (eMMC) and a host connected via a command/response channel, a clock channel, and a data channel,
wherein the eMMC includes an extended card specific device (EXT_CSD) register that stores eMMC information including busy control clock information, and
the host is configured to determine whether or not to provide a clock to the clock channel while the eMMC is in a busy state in response to the busy control clock information.

9. The eMMC system of claim 8, wherein the host comprises:
a clock generator that generate the clock; and
a host input/output (I/O) block, the host I/O block comprising:
an output clock signal selector that receives the clock and a clock disable signal and selects on the basis of a detection signal between the clock and the clock disable signal to generate an output clock signal provided to the clock channel while the eMMC is in the busy state.

10. The eMMC system of claim 9, wherein the host I/O block further comprises:
a busy signal detector that receives the clock and a busy signal communicated from the eMMC to the host via the data channel, wherein the busy signal detector generates the detection signal in response to the clock and the busy signal.

11. The eMMC system of claim 9, wherein the host is further configured to generate a command, and the eMMC comprises:
a command parser that receives the command via the command/response channel, and parses the command to generate a clock selection signal;
an input clock signal selector that receives the output clock via the clock channel and an internal clock, and selects on the basis of the clock selection signal between the output clock and the internal clock; and
a busy signal generator that generates the busy signal in response to the selected one of the output clock and the internal clock,

12. The eMMC system of claim 8, wherein the host is further configured to generate a SEND_EXT_CSD command and communicate the SEND_EXT_CSD command to the eMMC via the command/response channel, and
the eMMC is further configured to provide the eMMC information stored in the EXT_CSD register to the host via the data channel in response to the SEND_EXT_CSD command.

13. The eMMC system of claim 12, wherein the busy control clock information is stored in a BUSY_W/O_CLOCK field of the EXT_CSD register.

14. The eMMC system of claim 11, wherein the command is a R1b type command, and the busy signal is generated by the eMMC only after a predetermined time period after receiving the R1b type command.

15. A method of operating an eMMC system, the eMMC system including an embedded multimedia card (eMMC) and a host connected via a command/response channel, a clock channel, and a data channel, the method comprising:
operating the eMMC in response to a clock received from the host via the clock channel while the eMMC is in a busy state during a first eMMC operating mode; and
operating the eMMC in response to an internal clock generated within the eMMC while the eMMC is in the busy state during a second eMMC operating mode,
wherein the first and second eMMC operating modes are defined by eMMC information stored in an extended card specific device (EXT_CSD) register.

16. The method of claim 15, wherein the eMMC information includes busy control clock information.

17. The method of claim 16, further comprising:
changing from the first eMMC operating mode to the second eMMC operating mode in response to a SWITCH command communicated from the host to the eMMC in response to the busy control clock information.

18. The method of claim 16, further comprising:
communicating a SEND_EXT_CSD command from the host to the eMMC via the command/response channel; and
in response to the SEND_EXT_CSD command, communicating eMMC information stored in the EXT_CSD register including the busy control clock information to the host via the data channel.

19. The method of claim 16, wherein the busy control clock information is stored in a BUSY_W/O_CLOCK field of the EXT_CSD register.

20. The method of claim 16, wherein the eMMC enters the busy state only after a predetermined time period following receiving a R1b type command from the host.
